(19) United States
(12) Patent Application Publication
(10) Pub. No.: US 2013/0162028 A1
(43) Pub. Date: Jun. 27, 2013

(54) WIRING SYSTEM FOR CAR REVERSING CAMERA APPARATUS

(71) Applicant: Ian Bierley, San Jose, CA (US)

(72) Inventor: Ian Bierley, San Jose, CA (US)

(21) Appl. No.: 13/337,492

(22) Filed: Dec. 27, 2011

(51) Int. Cl. B60L 1/00

(52) U.S. Cl. 307/10.1

(57) ABSTRACT

Wiring for a car reversing camera system in which a single, long multicore cable carries power and signal wires from a rearward camera position to a forward monitor position. The multicore cable feature at least one narrow width connector that can pass through apertures in a vehicle chassis without drilling holes in the chassis. Power is provided to the long multicore cable from a junction unit that steals power from a car's electrical system that is actuated upon reversing.

### TECHNICAL FIELD

The invention relates to an electrical signal communication and, in particular, to a wiring system for automotive backup cameras, sometimes known as car reversing cameras.

### BACKGROUND ART

Car reversing cameras are known. Backup camera systems sold in the automotive aftermarket include a camera, a backup monitor, and mounting hardware. The cables typically include RCA connectors at opposite ends of the cables that are usually too large to fit through existing passageways from the forward end of vehicle to the rearward end. For example, passageways in the engine compartment firewall are typically just large enough to admit cable bundles or shafts that are part of the OEM design. In order to install an aftermarket camera system it is necessary to drill holes in the firewall as well as in other barriers which block the passage of a cable from the forward portion of a vehicle to the rearward portion where a camera is mounted. A typical system of the prior art is shown in published patent application, US2008/0030311 entitled System for Monitoring an Area Adjacent a Vehicle by M. Dayan, et al.

Backup camera systems of the prior art frequently use multiple cables for carrying electrical power and the camera signal. This results in a wire bundle that must pass through holes in the firewall and other barriers. To avoid holes, some camera system use wireless communication from the front of a car to the back. This introduces reliability problems because wireless is not as reliable as wire systems. Moreover, wireless system can cause r.f. interference with other car systems, or with phone systems. An object of the invention is to avoid the necessity of drilling holes in walls or barriers in the interior of a vehicle without using wireless communication.

### SUMMARY OF INVENTION

The above object has been met with a wiring system for a car reversing camera system that features multicore cables that carry both power and signal wires and having at least one narrow feed-through connector that can squeeze through existing apertures in the chassis and frame of a car. A single long multicore cable extends from a rearward region of a vehicle towards a forward region, through chassis and frame apertures, toward a forward region. At a forward region, a video monitor is connected to the long cable for receiving both power and signal. At a rearward region, a junction is provided that is an assembly station for power wires and the video signal from the camera. From the junction, one multicore cable runs to the camera for powering the camera and receiving the video signal, while another, longer, multicore cable runs to the monitor for powering the monitor the video signal. The junction has a pair of power wires running to backup lights or other powered item. When backup lights are actuated, power is stolen from the lights or other power source and flows to the junction where power is provided both to the camera, as well as to the long multicore cable that connects to the monitor and provides both power and video signal to the monitor.

### BRIEF DESCRIPTION OF DRAWINGS

FIG. 1 is a side plan view of a wiring system for a car reversing camera system installed in a motor vehicle.

FIG. 2 is a diagram of an arrangement of parts of the wiring system illustrated in FIG. 1.

FIG. 3 is an end view of a male connector for use in the wiring system of FIG. 2.

FIG. 4 is an end view of a female connector for use in the wiring system of FIG. 2.

### DETAILED DESCRIPTION

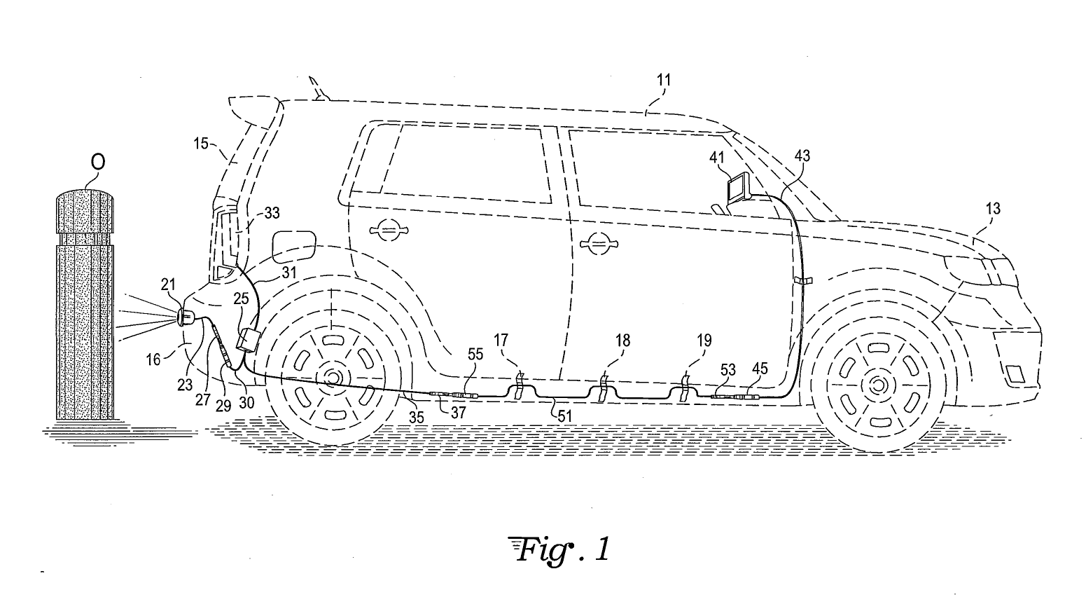

With reference to FIG. 1, a motor vehicle is seen having a forward region 13 and rearward region 15. When backing, the vehicle needs to avoid an object O, directly behind the vehicle. For this purpose a car reversing camera apparatus is used. Such an apparatus includes a camera 21 near the car bumper and a remote video monitor 41 near the driver. The camera 21 is a simple camera similar to cameras found in smart phones and laptop computers. Such cameras are powered by a low d.c. voltage, in this case 12 V, because this voltage is readily available in almost all cars. The video output signal from the camera is to be transmitted to the video monitor 41 which can be up to 20 feet away, possibly more. The camera has a video output signal wire 23 that terminates in a first video signal wire connector 27. The first video signal wire connector is joined to a second video signal wire connector 29 that relays the video forwardly along a short, multicore cable 30 into a junction unit 25 and then to a longer multicore cable 35 that emerges from the junction unit 25. First multicore cable 35 terminates in a first multicore connector 37. In turn, connector 37 is joined to a second end connector 55 of the long multicore cable 51.

The long multicore cable 51 passes through several apertures 17, 18, 19 associated with the undercarriage or chassis of motor vehicle 11. The multicore cable 51 carries not only the video signal but also carries DC power which is stolen from an automotive accessory associated with car reversing, such as taillights. The stolen power goes into junction unit 25 on power wires 31 and then emerges from junction unit 25 in the first multicore cable 35 and the short multicore cable 30. First multicore cable 35 is connected to the long multicore cable 51. At least one end of the cable 51 has a narrow connector, less than 7 mm in diameter, that can pass through existing chassis apertures, such as the chassis apertures 17, 18 and 19 which are pre-existing and might be used for carrying other cables. The apertures 17, 18, 19 are exemplary and there could be more than 3 apertures, or fewer. In any event, narrow apertures are contemplated, already filled with cables. The wire 51 with at least one narrow connector can squeeze through existing apertures without creating new holes. The narrow first end connector 53 is joined to monitor connector 45. The video monitor 41 has a second multicore cable 43 connector connected to the monitor and also connected to the long multicore cable 51 through monitor connector 45. The long multicore cable 51 feeds the second multicore cable 43 with DC power as well as the video signal from the camera 21. The video monitor 41 may be an after-market monitor, similar to GPS monitors, or may be a monitor shared with a GPS navigation system, or the like.

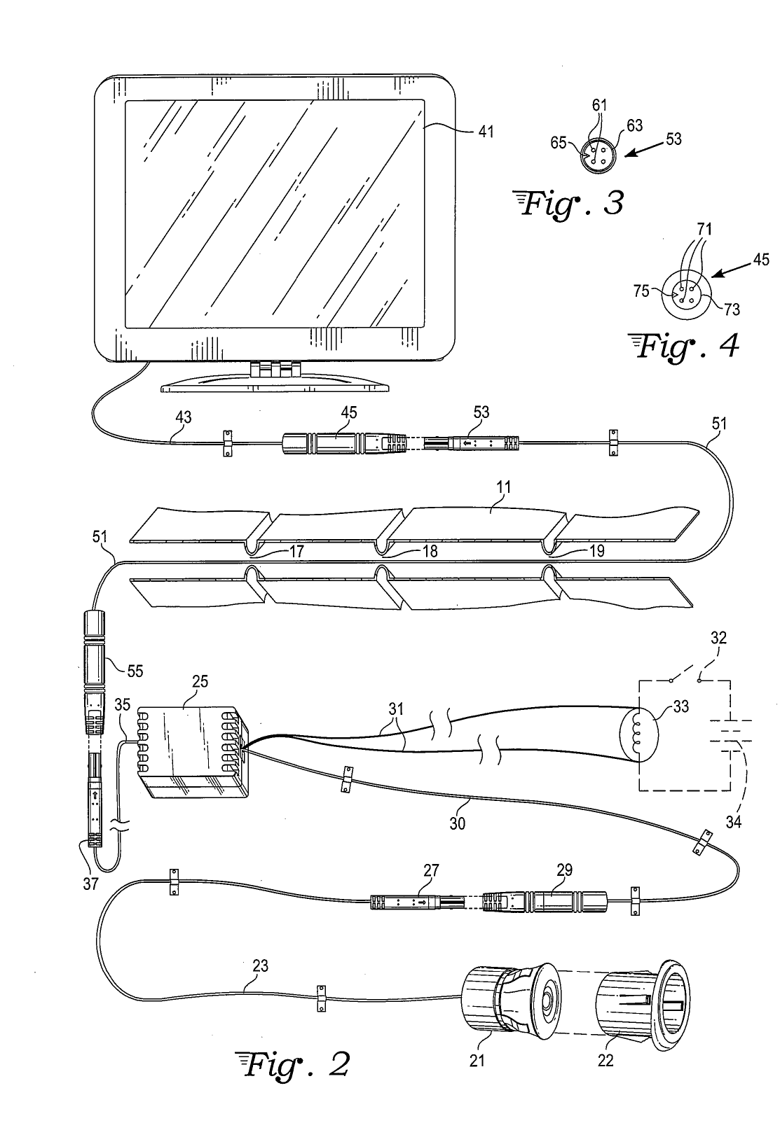

In FIG. 2, the camera 21 is seen fitting into the camera holder 22 which may be mounted in a car rear bumper or a rear panel. Both the camera 21 and the monitor 41 receive DC power from junction unit 25 mounted in a location in the auto chassis where power can be stolen from a source associated with auto reversing. Such a location could be the trunk of a car. Although the junction unit is shown to be closer to the camera than the monitor, an opposite arrangement has been tested where the junction unit is closer to the monitor than the camera. In the latter situation power is stolen from a nearby source that is triggered by the backup lights. In FIG. 1, an electrical power source may be seen to be the tail lamps 33 that are powered from a car's electrical system. The electrical system is represented by battery 34 and an actuator switch 32, for example, a relay associated with backing. In this example the actuator switch 32 energizes taillight 33 from the car electrical system. The voltage across taillight 33, taken to be 12 V, is stolen by wires 31 and passed to the junction unit 25. Alternatively, power may be stolen from an automotive relay powered by 12 V but the trigger still comes from a taillight or the associated actuator switch. Inside of junction unit 25 is a simple solder terminal circuit board where power can be applied to pairs of wires in the multicore cables 30 and 35 for powering the camera 21 and the monitor 41, respectively. Where the multicore cables have 4 wires, the fourth wire may be unused, while two wires are used for 12 volts DC power, or whatever voltage level is available, and a third wire carries the video signal wire. First multicore cable 35 emerging from junction 25 feeds the first multicore connector 37 which is connected to the second end connector 55 of the long multicore cable 51. The video signal and DC power on cable 51 pass through chassis apertures 17, 18 and 19 of motor vehicle 11 terminating in first end connector 53. The first end connector 53 is made to be particularly narrow, less than 7 mm in diameter, to pass through the apertures. The first connector 53 is connected to the monitor connector 45, passing the video signal and DC power through the second multicore cable 43 into the video monitor 41. Returning to junction unit 25, a third multicore cable 30 feeds power stolen from lamp 33 to camera 21 via the second video signal wire connector 29 and the first video signal wire connector 27. Connector 21 is similar in size and structure to connectors 37 and 53 while connector 29 is similar in size and structure to connectors 55 and 45.

FIG. 3 shows a cross-section of the first end connector 53. Four pins are attached to conductive wires surrounded by insulator material within sheath 63. There is an alignment notch 65 in the circumference of the sheath 63. In FIG. 4, the monitor connector 45 receives end connector 53 in a joining relationship. Four holes 71 receive the four pins 61. The holes are recessed in a shealth that forms a receptable for the four pins. The sheath is connected to a multicore cable, not shown. Insulative sheath 45 provides support for joining connector 53 with an alignment notch 75 that receives alignment notch 65 so that wires within the multicore cable can readily be identified and connected to proper terminals of the monitor on one end and the camera on the other end. Similar connections exist for connectors 37, 55 and 27, 29.

As an alternative to connectors 45 and 53, the second multicore cable 43 in FIG. 2 may be replaced by a single coaxial or multicore cable terminating in an RCA jack, solely for the video input signal to the monitor. Such a monitor has two power input wires that are connected to a power supply, but now may receive power from the inventive system. The narrow width connector 53 plugs into an adapter, not shown, that receives connector 53 and splits out video and power wires. The adapter has two output wires for power and an RCA receptacle for the RCA jack for transfer of the video signal from the camera. Such an adapter would allow use of some existing GPS LCD displays to be used with video from camera 21.

In operation, actuation of switch 32 brings power to junction unit 25 thereby activating both camera 23 and monitor 41 from a single power source. The video signal from the camera 23 is then routed via multicore cables to a compatible monitor 41. Routing is facilitated by the long multicore cable 51 that can be threaded through existing chassis apertures, without the need to make additional holes, using narrow width connectors.

What is claimed is:

1. A wiring system for a car reversing camera system where the car has an actuator for an electrical power actuated upon reversing comprising:
a camera and a monitor; and
a long multicore cable joining the camera and the monitor, the multicore cable having at least one power wire and a video signal wire, the power wire stealing power from electrical power system when actuated, the multicore cable having a narrow end less than 7 mm diameter that can be threaded through car apertures between the camera and the monitor.

2. The apparatus of claim 1 wherein a junction unit is disposed between the camera and the monitor, the junction unit having means for receiving stolen power from the car electrical system and providing stolen power to the power wire.

3. The apparatus of claim 2 wherein the camera is connected to the junction unit to receive electrical power through a multicore cable.

4. The apparatus of claim 2 wherein the monitor is connected to the junction unit to receive electrical power through a multicore cable.

5. The apparatus of claim 2 wherein the junction unit is connected to at least one backing light associated with the electrical power system.

6. A wiring system for a car reversing camera system in a motor vehicle having an electrical system partially activated upon vehicle reversing, the vehicle having forward and rearward regions and a plurality of apertures in blocked regions of the chassis and frame between the forward and rearward regions comprising:
a camera adapted to face rearwardly from a rearward region of the vehicle, the camera having a first video output signal wire and first and second power wires, all terminating in a junction unit having electrical leads adapted for stealing electrical power from powered items in the motor vehicle, the junction unit electrically joining the first and second power wires of the camera to the electrical leads from the powered items in a first multi-core cable that has third and fourth power wires and a second video output signal wire in a single sheath terminating in a first multi-core connector;
a video monitor supported in the forward region of the vehicle having a video signal input wire in a second multi-core cable also having fifth and sixth power wires, all terminating in a monitor connection;
a long multi-core cable with first and second ends and having a length of at least 2 meters and at least one of the first and second ends having a narrow feed-through connector having a diameter smaller than 7 millimeters, adapted to join the one of the first multi-core connector and the monitor connection with wire communication of power from the junction unit to both the camera and the video monitor and with wire communication of the video signal from the camera to the video monitor;
whereby the long multi-core cable communicates both power and video signal through existing apertures in the chassis and frame of the vehicle using the narrow feed-though connector to fit through said apertures, thereby passing through the vehicle from the camera to the junction unit and to the video monitor, communicating both power and the video signal when actuated by the powered items of the vehicle.

7. The system of claim 6 wherein the junction unit is a junction box mounted closer to the camera than to the video monitor.

8. The system of claim 6 wherein the powered items are backup lights that are powered when a vehicle is configured for travel rearwardly.

9. The system of claim 6 wherein the long multi-core cable has at least 3 wires.

10. The system of claim 6 wherein at least one of the first multi-core connector and the monitor connection has male pins received in a tubular housing into which the feed-through connector fits and has an electrical connection therewith.

11. The system of claim 10 wherein the narrow feed through connection is at the first end of the long multi-core cable and another narrow feed through connector is at the second end.

12. The system of claim 6 wherein the monitor connection of the video monitor is a first RCA connector and the long multi-core cable has a second RCA connector at an end thereof for joinder with the first RCA connector.

13. The system of claim 6 wherein the multi-core cable is 4-wire 26AWG cable.

14. The system of claim 6 wherein the multi-core cable is 4-wire telephone cable.

15. The system of claim 6 wherein the powered items are activated by an actuator upon vehicle reversing.
